(19) United States
(12) Patent Application Publication
(10) Pub. No.: US 2014/0305234 A1
(43) Pub. Date: Oct. 16, 2014

(54) VIBRATION EXCITER

(71) Applicant: ABI Anlagentechnik-Baumaschinen-Industriebedarf Maschinenfabrik und Vertriebsgesellschaft mbH, Niedernberg (DE)

(72) Inventors: Albrecht KLEIBL, Grosshennersdorf (DE); Christian HEICHEL, Niedernberg (DE)

(73) Assignee: ABI Anlagentechnik-Baumaschinen-Industriebedarf Maschinenfabrik und Vertriebsgesellschaft mbH, Niedernberg (DE)

(21) Appl. No.: 14/189,017

(22) Filed: Feb. 25, 2014

(30) Foreign Application Priority Data
Apr. 10, 2013 (EP) 13163222.6

(51) Int. Cl. B06B 1/16

(52) U.S. Cl. CPC B06B 1/16
USPC 74/61

(57) ABSTRACT

A vibration exciter, particularly for a vibration pile driver, includes at least two shafts disposed parallel to one another, as well as at least two imbalance masses, which are attached on one or more of the shafts. A pivot motor provided for adjustment of the relative rotational position of the imbalance masses with regard to one another, includes a pivot motor shaft and a pivot motor housing. The pivot motor shaft is an integral part of one of the shafts, and the rotational position of the pivot motor housing relative to the pivot motor shaft can be changed. The pivot motor is disposed axially offset, in such a manner that it is disposed outside of the regions through which the imbalance masses move.

### CROSS REFERENCE TO RELATED APPLICATIONS

Applicant claims priority under 35 U.S.C. §119 of European Application No. 13163222.6 filed Apr. 10, 2013, the disclosure of which is incorporated by reference.

### BACKGROUND OF THE INVENTION

1. Field of the Invention

The invention relates to a vibration exciter, particularly for a vibration pile driver.

2. Description of the Related Art

In construction, vibration generators such as vibrators, shakers, or vibration bears, are used to introduce profiles into the ground, or to draw them from the ground, or also to compact ground material. The ground is excited using vibration, and thereby achieves a “pseudo-fluid” state. The goods to be driven in can then be pressed into the construction ground using a static top load. The vibration has a linear movement and is generated by rotating imbalances that run in opposite directions, in pairs, within an exciter transmission. Vibration generators are characterized by the installed imbalance, called the “static moment.”

In order to achieve an optimal forward drive, i.e. good compaction, as a function of the goods being driven and the ground properties, it is desirable to regulate the amplitude, frequency or force direction of the vibration generator. It is practical if adjustment of the vibration takes place via change in the static moment or the phasing of the imbalances. To adjust the effective value of the imbalance, shafts having non-changeable imbalances are rotated relative to one another, or the active imbalance of each individual shaft is changed.

A particular construction is leader-mounted vibrators. These vibrators are usually equipped with three or four imbalance shafts. Adjustment of the static moment of the vibration generator takes place by means of adjustment of the effective imbalance of each shaft.

In this connection, a central imbalance is regularly rotated against two outer imbalances, in order to adjust the resulting imbalance in this way. Because the angle between the imbalances on all the imbalance shafts is supposed to be the same, the outer imbalances and the inner imbalances of all the shafts are usually synchronized with one another, in each instance, and combined into groups, using gear wheels, in this connection. All the imbalances whose phasing, relative to one another, remains unchanged when the static moment is changed, form an imbalance group. Regularly, all the inner imbalances form an imbalance group, as do all the outer ones. Coupling between these groups takes place by way of a pivot motor, which shifts the phasing between the imbalance groups or keeps it constant.

Such a vibration generator is described, for example, in DE 20 2007 005 283 U1. In this connection, the group of the outer imbalances and the group of the inner imbalances are driven separately, by way of a drive, in each instance. The pivot motor solely serves for adjustment of the phasing of the imbalance groups relative to one another.

The previously known vibration generator has the disadvantage of a great multiplicity of parts. In the case of such a vibration generator having four imbalance shafts and one pivot motor disposed centrally, fourteen gear wheels are required with three rows of gear wheels, for example. Furthermore, the maximal torque of the pivot motor is limited, because its outside diameter is limited by the adjacent imbalances.

### SUMMARY OF THE INVENTION

The invention wants to provide a remedy for these disadvantages. The invention is based on the task of making available a vibration generator whose multiplicity of parts is reduced and in which restrictions of the maximal torque of the pivot motor are avoided. According to the invention, this task is accomplished by a vibration exciter, particularly for a vibration pile driver, comprising at least two shafts disposed parallel to one another, as well as at least two imbalance masses, which are attached on one or more of the shafts. A pivot motor is provided for adjustment of the relative rotational position of the imbalance masses with regard to one another. The pivot motor comprises a pivot motor shaft and a pivot motor housing, wherein the pivot motor shaft is an integral part of one of the shafts, and the rotational position of the pivot motor housing relative to the pivot motor shaft can be changed. The pivot motor is disposed axially offset, in such a manner that it is disposed outside of the regions through which the imbalance masses move.

With the invention, a vibration exciter is created, the multiplicity of parts of which is reduced, and in which restrictions of the maximal torque are avoided. Because the pivot motor is disposed axially in such a manner that it is positioned outside of the regions through which the imbalance masses move, only the pivot motor shaft is situated in the region between the imbalances. Therefore the imbalances can be structured with a greater outside diameter, at the same distance between axes. Likewise, the outside diameter of the pivot motor is not limited by adjacent imbalances. Now, only two rows of gear wheels are necessary, because of the placement of the pivot motor according to the invention, and thereby the multiplicity of parts is reduced.

In a further development of the invention, at least one of the shafts disposed parallel to one another, and, in addition, the pivot motor shaft of the pivot motor or the pivot motor housing of the pivot motor, are connected with the drive. As a result, the stress on the pivot motor itself is reduced, because no drive moments have to be transferred by it. The drive motor that turns the shaft end of the pivot motor drives a series of gear wheels, by way of the gear wheel attached on the pivot motor shaft, which series is connected with the central imbalance, in each instance, of each shaft. The drive moment is transferred to the imbalance by way of this shaft, but the pivot mechanism of the pivot motor does not lie within the force flow of the drive moment. The same effect occurs if the pivot motor housing is connected with the drive motor.

In another embodiment of the invention, at least one of the drives is configured as a hydraulic motor having an adjustable displacement. In this way, the possibility exists of influencing the size and the direction of the moment to be transferred by the pivot motor, by means of changing the ratio of the displacement of the motors that drive the two imbalance groups, and thereby the pivot motor can be supported or braked in its pivot movement.

In a further embodiment of the invention, the pivot motor is a rotary vane pivot motor. Preferably, the rotary vane pivot motor is configured with one vane and has a pivot angle greater than 210 degrees, preferably greater than 240 degrees, particularly preferably greater than 270 degrees, in order to rotate the imbalances by 180 degrees relative to one another. In this way, an increase in torque is made possible by way of a transmission translation, whereby better utilization of the construction space is brought about.

In another embodiment of the invention, the pivot motor shaft and the pivot motor housing are provided, in each instance, with at least one gear wheel, which engages into a gear wheel connected with an imbalance mass disposed on one of the shafts, in each instance. In this connection, the at least one gear wheel disposed on the pivot motor shaft has a smaller diameter than the gear wheel that is in engagement with this gear wheel and is connected with an imbalance mass. In this way, a translation ratio is achieved, thereby increasing the acting torque. Because of the defined, required torque for adjustment of the imbalances relative to one another, a reduction in the torque to be provided by the pivot motor is thereby achieved. For this reason, the motor can be dimensioned to be smaller or can be operated at a lower pressure.

In a further development of the invention, no seals are provided for sealing the pivot motor housing with regard to the pivot motor shaft of the at least one pivot motor, whereby the sealing effect is brought about exclusively by way of the gap dimension. In this way, the maintenance effort is reduced, because replacement of aged or worn seals, or seals that have become brittle at overly high temperatures, is not necessary. Instead, the sealing effect is achieved by way of narrow gaps. The risk of greater leakage is countered by operation at a lower pressure, which can be balanced out by the dimensioning of the pivot motor or of the transmission translation of the gear wheels that are in engagement.

In another embodiment of the invention, the pivot motor shaft of the pivot motor is provided with an axial bore into which a fixed lance projects. This lance has at least two channels for supplying oil to the pivot motor, which channels open into a ring groove disposed on the outside of the lance, in each instance, whereby radial bores for connecting the at least two ring grooves of the lance with the chambers to be supplied are introduced into the pivot motor shaft.

In this connection, the fit between lance and shaft bore in the region of the ring grooves is preferably structured as a tight slide bearing. The lance is preferably coated with plastic in this region. The provision of such a fixed lance counters the problem of the rotary feed-throughs usually used in the state of the art, which consist of a fixed housing that is flanged onto the housing of the vibration exciter, and a rotor that is mounted so as to rotate in this housing and is also driven by the rotating pivot motor.

Bearings always demonstrate bearing play, and thereby all the components mounted in a vibrating housing rotate at a certain eccentricity. While these eccentricities are relatively large in the case of self-mounted pivot motors, very tight plays are required in rotary feed-throughs, for reasons of sealing technology. A direct, rigid connection between the rotor of the rotary feed-through of the pivot motor shaft is not possible, because the heavy pivot motor would damage the sensitive bearings of the rotary feed-through. The lance, which is disposed in fixed manner, on the other hand, balances out the dancing movements of the pivot bearing shaft in the roller bearings, which demonstrate play as part of their function. This balancing is done, on the one hand, via the long shaft of the lance, which is preferably structured to be elastic, and is advantageously structured, via an attachment on the flange, in such a manner that the lance can assume slightly slanted positions. In this connection, the lance is preferably mounted, on the end side, with play in a flange part situated on the housing of the vibration exciter, so as to prevent rotation.

In a further development of the invention, the lance, on the end side, has a head piece that is increased in diameter, with which it is mounted in the flange part. For this purpose, resilient attachment of the lance in the flange is made possible. For this purpose, the gap between lance and flange part that is formed by the play is preferably bridged by at least one O-ring. The lance can be secured to prevent rotation, by means of a pin that engages into the head piece.

### BRIEF DESCRIPTION OF THE DRAWINGS

Other further developments and embodiments of the invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 is a schematic representation of a vibration generator in a spatial view;

FIG. 2 is a schematic representation of the rotary vane pivot motor of the vibration generator from FIG. 1 in cross-section (vanes not shown);

FIG. 3 is a schematic representation of the lance of the arrangement from FIG. 2 with flange part disposed on it, in cross-section, and

FIG. 4 is a schematic representation of the rotary vane of the rotary vane pivot motor from FIG. 2.

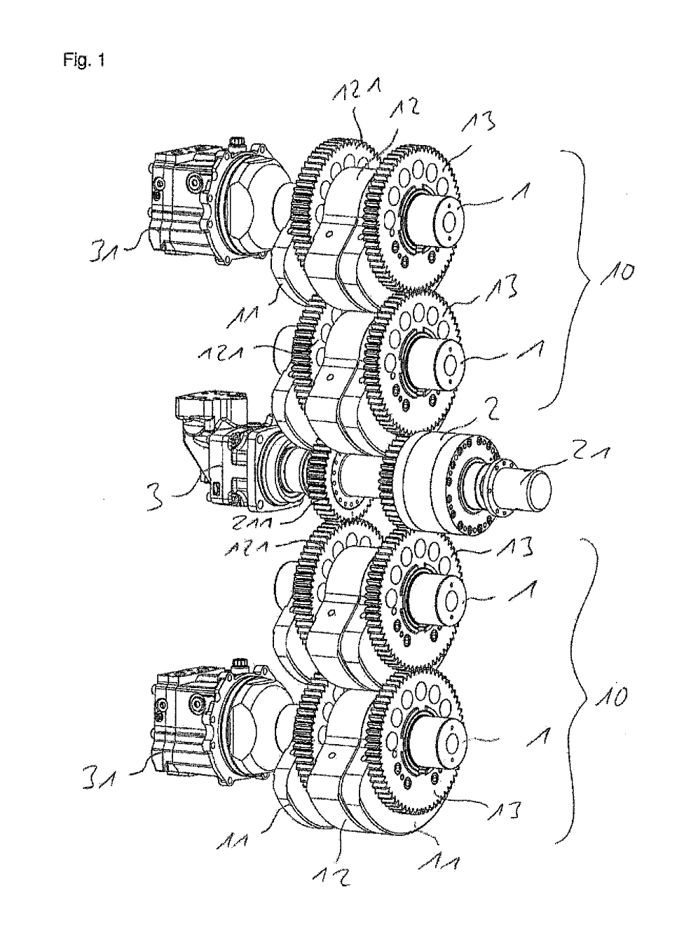

### DETAILED DESCRIPTION OF PREFERRED EMBODIMENTS

The vibration exciter selected as an exemplary embodiment is structured as a four-shaft vibrator transmission. Four imbalance shafts 1 are provided, on which two outer imbalance masses 11 are attached at a distance from one another. Centered between the two outer imbalance masses 11, a central imbalance mass 12 is provided, which is connected with a gear wheel 121. Furthermore, a further gear wheel 13 is attached on the imbalance shaft 1, at its end facing the pivot motor 2. The imbalance shafts 1 are disposed parallel to one another, in such a manner that the gear wheels 121, 13 of two imbalance shafts 1, in each instance, stand in engagement with one another, so that two imbalance shaft groups 10 are formed. The two imbalance shaft groups 10 are coupled with one another by way of the gear wheels 211, 221 of a pivot motor 2.

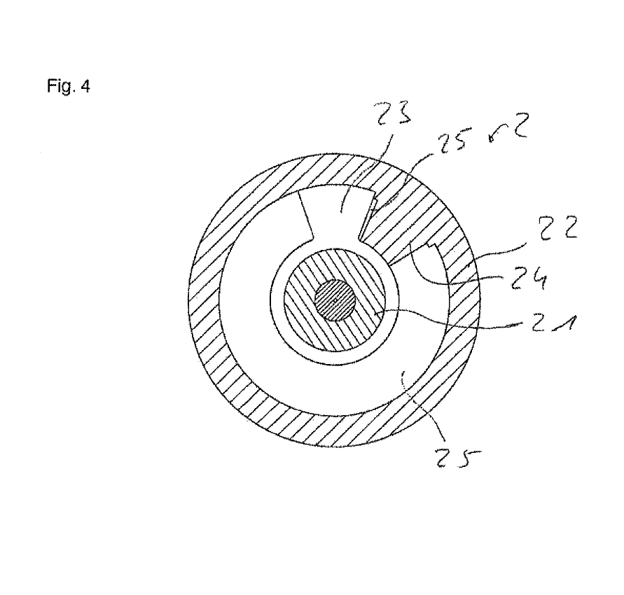

The pivot motor 2 comprises a pivot motor shaft 21 as well as a pivot motor housing 22, whereby the rotational position of the pivot motor housing 22 relative to the pivot motor shaft 21 can be changed. A vane 23 is formed onto the pivot motor shaft 21, which vane can rotate within the pivot motor housing 22. See FIG. 4. Within the pivot motor housing 22, a stop 24 is formed on, by means of which the pivot angle of the vane 23 is limited. A chamber 25 is delimited, in each instance, between the stop 24 and the vane 23, on both sides of the vane 23. A gear wheel 211 is attached to the pivot motor shaft 21, which gear wheel stands in engagement with a gear wheel 121 of a central imbalance mass 12 of an imbalance shaft 1 of an imbalance shaft group 10, in each instance. Parallel to the gear wheel 211, at a distance from it, a gear wheel 221 is disposed on the pivot motor housing 22 of the pivot motor 2, which gear wheel is in engagement with a gear wheel 13 of an imbalance shaft 1 of an imbalance shaft group 10, in each instance. In this connection, the pivot motor 2, with its pivot motor housing 22, as well as the vane 23 formed onto the pivot motor shaft 21, which vane is disposed in the housing so as to rotate, is disposed axially offset so that the pivot motor is disposed outside of the regions through which the imbalance masses 11, 12 move.

In the exemplary embodiment, the end of the pivot motor shaft 21 that faces the gear wheel 211 is driven by a hydraulic motor. A conventional gear shaft adapter is used as a coupling between the gear shaft—not shown—of the hydraulic motor 3 and the pivot motor shaft 21. In this connection, the diameter of the pivot motor shaft 21 is selected to be clearly greater than in the case of a conventional pivot motor such as that used in DE 20 2007 005 283 U1, for example. Installation of the pivot motor 2 takes place from the end of the pivot motor shaft 21 that lies opposite the hydraulic motor 3. The two outer imbalance shafts 1 of the vibrator transmission are also connected with a hydraulic motor 31. In the exemplary embodiment, the hydraulic motor 3, which drives the pivot motor 2, is a constant motor; the hydraulic motors 31 are hydraulic motors having an adjustable displacement. The displacement of the two hydraulic motors 31 having an adjustable displacement can be adjusted precisely so that the pivot motor 2 does not transfer any drive moment. Alternatively, the hydraulic motor 3 on the pivot motor may be configured as an adjustable motor, along with at least one of the two other hydraulic motors 31. In this case, the displacements of the drive motors may be adjusted so that the pivot motor is freed of drive moment, even if different speeds of rotation are used at a constant volume stream

In the exemplary embodiment, the gear wheels 211, 221 of the pivot motor 2 are configured to be smaller than the gear wheels 121, 13 of the imbalance shafts 1. In this connection, the pivot motor 2 is configured in such a manner that the vane 23 has a pivot angle of 280 degrees within the pivot motor housing 22. The translation of the gear wheels 211, 221 of the pivot motor 2 relative to the gear wheels 121, 13 of the imbalance shafts 1 is selected in such a manner that a rotation of the pivot motor housing 22, with the gear wheel 221 disposed on it, by 280 degrees relative to the pivot motor shaft 21, brings about a relative rotation of the gear wheels 13 attached to the imbalance shafts 1, relative to the gear wheels 121 disposed on the central imbalance masses 12, by 180 degrees.

The hydraulic motor 3 that turns the pivot motor shaft 21 drives a series of gear wheels 121 that are connected with the central imbalance mass 12, in each instance, of each imbalance shaft 1, by way of the gear wheel 211 that is attached to the pivot motor shaft 21 and lies closest to the hydraulic motor 3. In this connection, the hydraulic motor 3 does drive the pivot motor shaft 21, and the drive moment is transferred to the imbalances 12 by way of this pivot motor shaft 21; however, the pivot mechanism of the pivot motor 2 does not lie within the force flow of the drive moment. The two other, outer hydraulic motors 31 drive the outer imbalance masses 11 of each imbalance shaft 1, which are connected with one another by way of the gear wheels 13. The present vibrator transmission is characterized, as compared with the previously known vibration generators, in that the gear wheel trains are clearly shortened. If the outputs of all the gear wheel pairings that are to be transferred are added up, the least sum results for the present vibrator transmission. This arrangement results in lesser mechanical losses and lesser noise development.

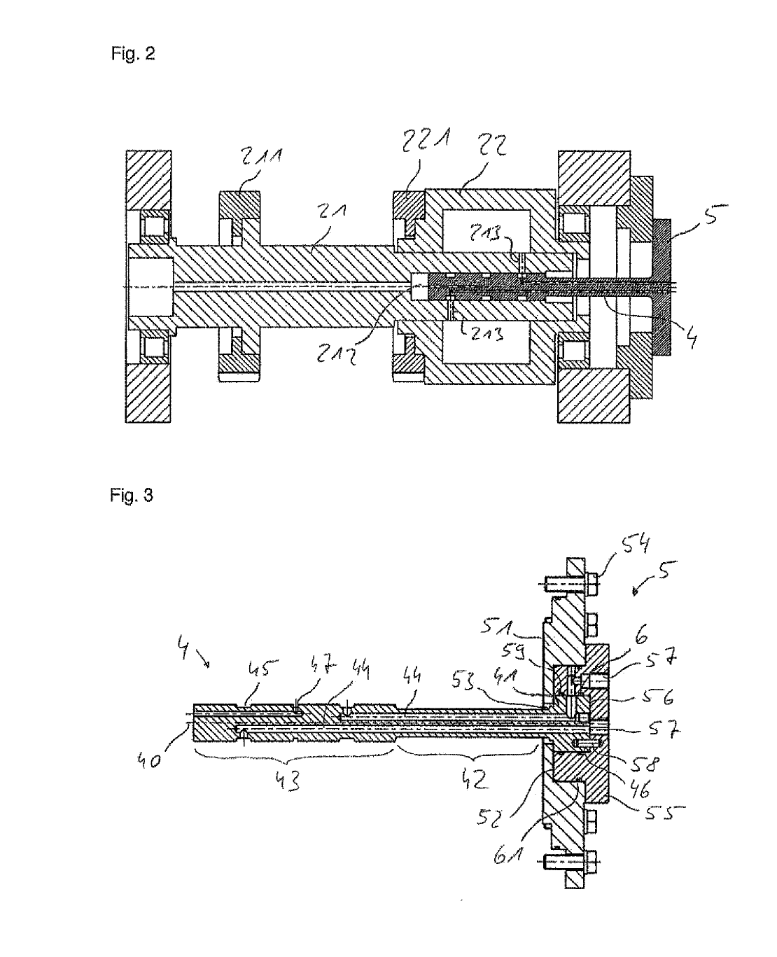

The pivot motor shaft 21 of the pivot motor 3 is provided with an axial bore 212 in the exemplary embodiment, from which bore two radial bores 213, at a distance from one another, are passed to the outside. See FIG. 2. In the axial bore 212 of the pivot motor shaft 21, a lance 4 is introduced to supply the chambers 25 of the pivot motor 2, which is configured as a rotary piston pivot motor, with hydraulic oil. The lance 4 is configured essentially cylindrically. On the end side, the lance 4 has a headpiece 41, followed by a shaft 42, which makes a transition into a slide bearing section 43 that is greater in diameter. See FIG. 3. In the lance 4, two channels 44 for supplying the chambers 25 of the pivot motor 2 are introduced, coaxial to its center axis 40. The channels 44 open into a ring groove 45 disposed within the slide bearing section 43, in each instance, which groove is disposed in such a manner that one of the radial bores 213 of the pivot motor shaft 21 is disposed orthogonal to it, which axial bore 212 represents the connection to the chamber 25 of the pivot motor 2, in each instance. Sealing of the ring grooves 45 relative to the pivot motor shaft 21 takes place by way of a very narrow gap between the slide bearing section 43 and the inner wall of the axial bore 212 of the pivot motor shaft 21, whereby the slide bearing section 43 is provided with a slide bearing coating of plastic in the exemplary embodiment.

The lance 4 is mounted, with its headpiece 41, on a flange part 5 that is attached, by way of screws 54, on the housing—not shown—of the vibrator transmission. The flange part 5 essentially consists of a base plate 51 that is provided, in the center, with a recess 52 configured in pot shape, which aligns with a bore 53 passed through the base plate 51. The pot-shaped configuration of recess 52 accommodates the lid part 55, which is provided with a centrally disposed, cylindrically configured recess 56, the outside diameter of which is slightly greater than the outside diameter of the headpiece 41 of the lance 4.

The lid part 55 is provided with supply connections 57 for supplying the channels 44 of the lance 4 accommodated by the lid part 55. Furthermore, an alignment pin 58 for engagement into an eccentric alignment bore 46 disposed in the headpiece 41 of the lance 4 is provided in the recess 56 of the lid part 55. Circumferentially around the recess 56 of the lid part 55, two ring grooves 59 for accommodation of one O-ring 6 each are introduced, parallel to one another. The O-rings 6 bridge the gap between the headpiece 41 of the lance 4 and the recess 56 of the lid part 55, thereby mounting the headpiece 41 in the lid part 55 so as to pivot slightly. The lid part 55 is attached in the recess 52 of the base plate 51 and accommodates the headpiece 41 of the lance 4, the shaft 42 of which projects through the bore 53 of the base plate into the axial bore 212 of the pivot motor shaft 21 of the pivot motor 2. In this connection, the lid part 55 is sealed with regard to the pot-shaped recess 52, by means of an O-ring 61.

The angle of rotation is limited by the vane formed onto the pivot motor shaft 21, in interaction with the stop 24. The vane 23 simultaneously serves as a seal between the two chambers 25 that are delimited between the vane 23 and the pivot motor housing 22 as well as the pivot motor shaft 21. The two chambers 25 are supplied with hydraulic oil that is supplied by way of the radial bores 213 of the pivot motor shaft 21. In order to supply the hydraulic oil to the rotating pivot motor shaft 21, the fixed lance 4 is mounted in the centric bore 212 that runs axially. The sealing effect is achieved by way of tight gaps.

The hydraulic oil is supplied to the channels 44 of the lance 4 via the supply connectors 57. From these channels 44, the oil gets into the rings grooves 45 on the outside of the lance. The chambers 25 of the pivot motor 2 are connected by means of the radial bores 213, which connect the ring groove space, in each instance, with the corresponding chamber 25. Sealing of the ring grooves 45 relative to one another takes place by way of a narrow gap. In the exemplary embodiment, a leakage ring groove 47 is disposed between the two ring grooves 45; this groove serves to conduct away any leakage oil that occurs. The fit between the lance 4 and the axial bore 212 of the pivot motor shaft 21 is structured as a tight slide bearing in the region of the ring grooves 45, 47. In this region, the lance 4 is provided with a slide bearing coating of plastic. A certain amount of leakage exits through the leakage ring groove 47 between the axial bore 212 of the pivot motor shaft 21 and the slide bearing section 43 of the lance 4 of certain slide bearings, but this leakage simultaneously lubricates the bearings, separates the surfaces, and thereby counteracts wear.

Although only a few embodiments of the present invention have been shown and described, it is to be understood that many changes and modifications may be made thereunto without departing from the spirit and scope of the invention.

What is claimed is:

1. A vibration exciter comprising
(a) at least first and second parallel shafts;
(b) at least first and second imbalance masses attached on at least one of the shafts; and
(c) a pivot motor for adjustment of a relative rotational position of the first and second imbalance masses with regard to one another, said pivot motor comprising a pivot motor shaft and a pivot motor housing and being integrated into one of the shafts;
wherein a rotational position of the pivot motor housing relative to the pivot motor shaft is adjustable; and
wherein the pivot motor is disposed axially offset so that the pivot motor is disposed outside of regions through which the imbalance masses move.

2. The vibration exciter according to claim 1, wherein at least one of the shafts and the pivot motor shaft of the pivot motor or the pivot motor housing of the pivot motor are connected with a drive.

3. The vibration exciter according to claim 2, further comprising a plurality of drives, wherein at least one of the drives is configured as a hydraulic motor with an adjustable displacement.

4. The vibration exciter according to claim 1, wherein the pivot motor is a rotary vane pivot motor.

5. The vibration exciter according to claim 4, wherein the pivot motor is configured with one vane and has a pivot angle greater than 210°.

6. The vibration exciter according to claim 5, wherein the pivot angle is greater than 240°.

7. The vibration exciter according to claim 5, wherein the pivot angle is greater than 270°.

8. The vibration exciter according to claim 5, wherein the first imbalance mass is disposed on the first parallel shaft and the second imbalance mass is disposed on the second parallel shaft and the pivot motor shaft has at least a first gear wheel engaging into a second gear wheel connected with the first imbalance mass and the pivot motor housing has at least a third gear wheel engaging into a fourth gear wheel connected with the second imbalance mass.

9. The vibration exciter according to claim 8, wherein the first gear wheel disposed on the pivot motor shaft has a smaller diameter than the second gear wheel that is connected with the first imbalance mass.

10. The vibration exciter according to claim 1, wherein no seals are provided for sealing the pivot motor housing with regard to the pivot motor shaft of the pivot motor, and wherein a sealing effect is brought about exclusively by way of a gap dimension.

11. The vibration exciter according to claim 10, further comprising an axial bore provided in the pivot motor shaft of the pivot motor, a fixed lance projecting into the axial bore and comprising first and second channels for supplying oil to the pivot motor opening respectively into first and second ring grooves disposed on an outside portion of the lance, and radial bores provided in the motor shaft for connecting the first and second ring grooves with chambers of the pivot motor to be supplied.

12. The vibration exciter according to claim 11, wherein a fit between the lance and the axial bore of the pivot motor shaft is structured as a tight slide bearing near the ring grooves of the lance.

13. The vibration exciter according to claim 11, further comprising a housing, wherein the lance has an end side mounted with play in a flange part attached to the housing so as to prevent rotation.

14. The vibration exciter according to claim 13, wherein the lance, on the end side, has a head piece having an increased diameter for mounting the lance in the flange part.

15. The vibration exciter according to claim 13, further comprising at least one O-ring, wherein the play forms a gap between the lance and the flange part and the gap is bridged by the at least one O-ring.
